(19) United States
(12) Patent Application Publication
(10) Pub. No.: US 2025/0326258 A1
(43) Pub. Date: Oct. 23, 2025

(54) METHOD FOR IDENTIFYING TIRE PRESSURE MONITORING SENSORS

(71) Applicant: TSUNG-HSIEN LEE, TAIPEI CITY (TW)

(72) Inventor: TSUNG-HSIEN LEE, TAIPEI CITY (TW)

(21) Appl. No.: 19/183,949

(22) Filed: Apr. 21, 2025

(30) Foreign Application Priority Data
Apr. 23, 2024 (TW) 113115113

(51) Int. Cl. B60C 23/04; G01L 17/00; G01M 17/02; G01P 7/00

(52) U.S. Cl. CPC B60C 23/0488; B60C 23/0416; G01L 17/00; G01M 17/02; G01P 7/00

(57) ABSTRACT

A method for identifying tire pressure monitor sensors includes the following steps: each wheel tire pressure monitor calculates the rotational speed value of the corresponding wheel; the vehicle electronic control unit reads the information of each wheel's ABS gear; each tire pressure monitor sets the same target angular position; each tire pressure monitor calculates the time value needed to reach the target angular position based on the rotational speed value of the corresponding wheel; each tire pressure monitor wirelessly transmits a packet of the calculated time value to the vehicle electronic control unit based on the time values transmitted by each tire pressure monitor. When the time value transmitted by any tire pressure monitor is reached, the vehicle electronic control unit reads the corresponding tooth count value of each wheel's ABS gear at the target angular position, and the computing element identifies which tire pressure monitor belongs to which wheel.

### BACKGROUND OF THE INVENTION

### 1. Fields of the Invention

The present invention relates to a method for identifying which tire pressure monitoring sensors belong to which wheels, in order to facilitate the vehicle onboard computer and the vehicle owner in identifying the current tire pressure values of each wheel.

### 2. Descriptions of Related Art

Tire pressure values are important indicators of whether a vehicle can be driven safely. With technological developments, the methods for detecting tire pressure values have changed significantly, from previous manual measurements of each wheel, to current automatic measurements by various electronic devices that transmit data to monitoring screens for display. This not only makes it easier for vehicle owners to recognize, but the digitized values can also be used with the vehicle onboard computer to set alarm values.

Among the more common electronic devices are tire pressure monitors, which have built-in components for tire pressure detection. These are paired with battery-powered electronic modules that can connect and share information with the matched vehicle onboard computer, facilitating the onboard computer reading of each tire pressure monitor values, and allowing users to view tire pressure values on the onboard computer.

Generally speaking, conventional vehicles have four wheels, so four tire pressure monitors need to be installed separately on the left front wheel, the right front wheel, the left rear wheel, and the right rear wheel. However, since these four tire pressure monitors are identical products, it is difficult for the vehicle onboard computer to identify which tire pressure monitor value belongs to which wheel (left front, right front, left rear, or right rear). Based on vehicle characteristics, the optimal tire pressure values for front wheels and rear wheels are different. Therefore, whether it is for the onboard computer tire pressure alarm settings, or for the vehicle owner judgment of whether tire pressure values are abnormal, being able to correctly identify which tire pressure monitor belongs to which wheel is necessary. Hence, it is essential to develop a method for identifying which tire pressure monitor belongs to which wheel, to facilitate the vehicle onboard computer and the vehicle owner in correctly interpreting the tire pressure values of each wheel.

The present invention intends to provide a method for identifying which tire pressure monitoring sensors belong to which wheels to eliminate shortcomings mentioned above.

### SUMMARY OF THE INVENTION

The present invention relates to a method for identifying tire pressure monitor sensors, comprising the following steps:

A tire pressure monitor of each wheel calculating a rotational speed value of a corresponding wheel;

A vehicle electronic control unit reading an information of each wheel's ABS gear;

Each tire pressure monitor setting a same target angular position, and each tire pressure monitor calculating a time value needed to reach the target angular position based on the rotational speed value of the corresponding wheel, and

Each tire pressure monitor wirelessly transmitting a packet of the calculated time value to a vehicle electronic control unit.

When the time value transmitted by any tire pressure monitor is reached, the vehicle electronic control unit reads a corresponding tooth count value of each wheel's ABS gear at the target angular position. After obtaining multiple corresponding tooth count values, a computing element identifies which tire pressure monitor belongs to which wheel based on whether the corresponding tooth counts of each tire pressure monitor are shown and concentrated in a specific tooth count range or in a dispersed state.

The primary object of the present invention is to achieve the identification of which tire pressure monitor belongs to which wheel. The preset invention primarily uses information from the ABS gear for identification. The timing at which the vehicle electronic control unit (ECU) reads the information of each wheel's ABS gear through the controller is based on the time value needed for each tire pressure monitor to reach a target angular position. This time value serves as the timing point for the vehicle electronic control unit to record the information of each wheel's ABS gear, thereby achieving the purpose of identifying which tire pressure monitor belongs to which wheel.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a schematic diagram of a vehicle system architecture applying the method of the present invention;

FIG. 2 is an example illustration showing how each tire pressure monitor calculates the time value needed to reach the target angular position based on the rotational speed value of the corresponding wheel;

FIG. 3 is a schematic diagram of the right front wheel tire pressure monitor reaching the target angular position, and

FIG. 4 is a schematic diagram of the right rear wheel tire pressure monitor reaching the target angular position.

### DETAILED DESCRIPTION OF THE PREFERRED EMBODIMENT

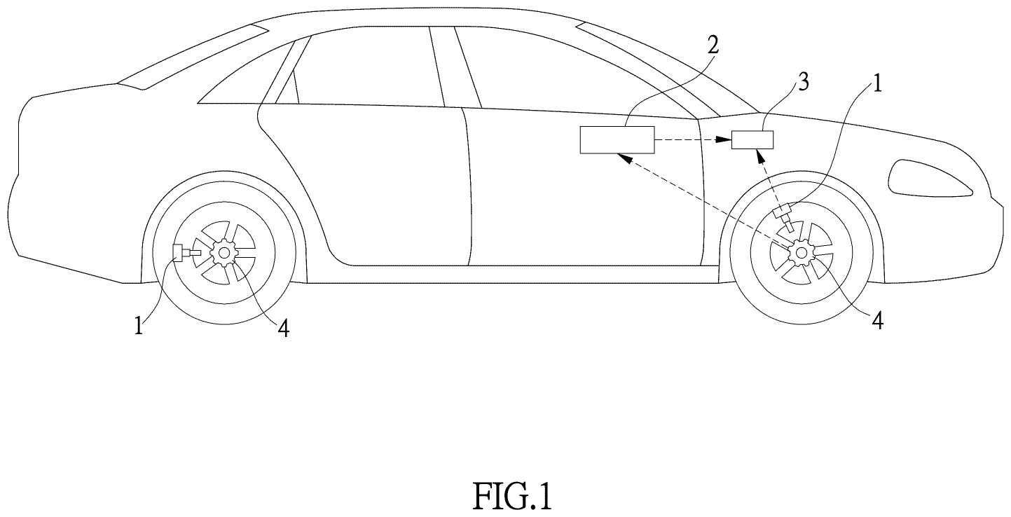

Referring to FIGS. 1 to 4, the method for identifying tire pressure monitor sensors of the present invention comprises the following steps:

Each wheel tire pressure monitor 1 calculates the rotational speed value of the corresponding wheel.

The vehicle electronic control unit 2 (ECU, Electronic Control Unit, vehicle onboard computer) reads (for example, through a controller 3 which can be the ABS controller in the ABS system) the information of each wheel's ABS gear 4 (ABS is the abbreviation for Anti-Lock Brake System).

Each tire pressure monitor 1 sets the same target angular position 5, and each tire pressure monitor 1 calculates the time value (T) needed to reach the target angular position 5 based on the rotational speed value of the corresponding wheel.

Each tire pressure monitor 1 wirelessly transmits the packet of the calculated time value to the vehicle electronic control unit 2, based on the time values transmitted by each tire pressure monitor 1. When the time value transmitted by any tire pressure monitor 1 is reached, the vehicle electronic control unit 2 reads the corresponding tooth count value of each wheel's ABS gear 4 at the target angular position 5. After obtaining several corresponding tooth count values, the computing element (which can be located inside the vehicle electronic control unit 2 or inside a computer or the controller 3 connected to the vehicle electronic control unit 2) identifies which tire pressure monitor 1 belongs to which wheel based on whether the corresponding tooth counts of each tire pressure monitor 1 are shown and concentrated in a specific tooth count range or in a dispersed state.

The types of tire pressure monitors in the present invention can be valve stem tire pressure monitors, TPM (Tire Pressure Monitoring) sensors; or patch-type detectors, TMS (Tire Mount Sensors).

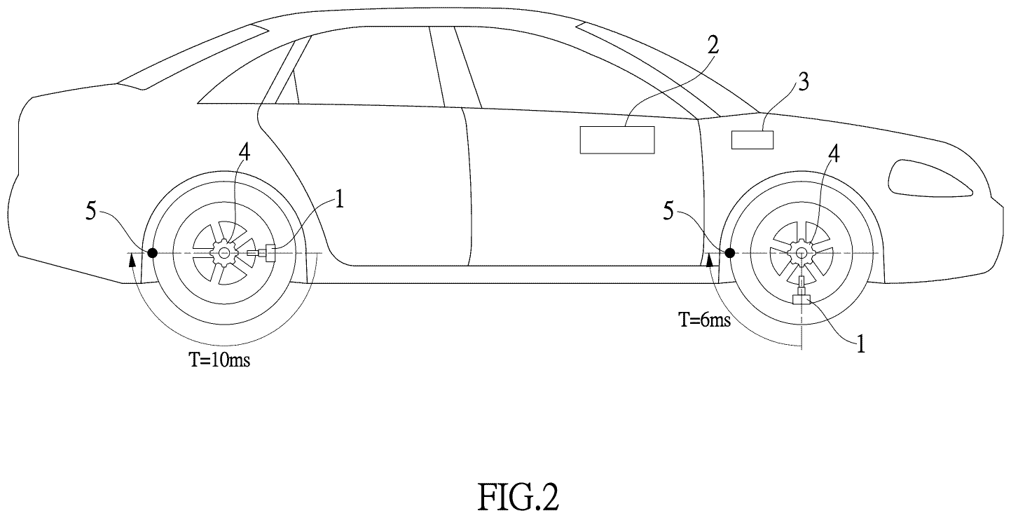

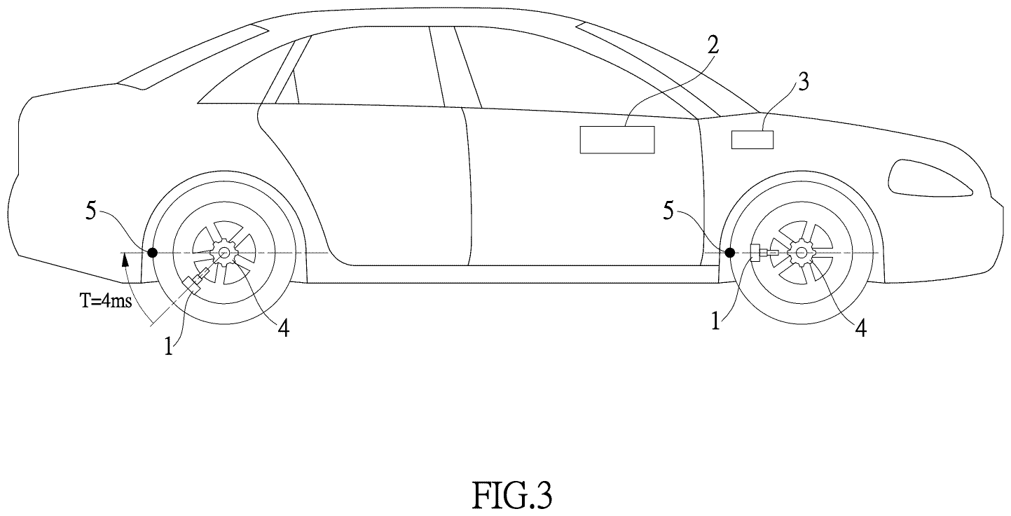

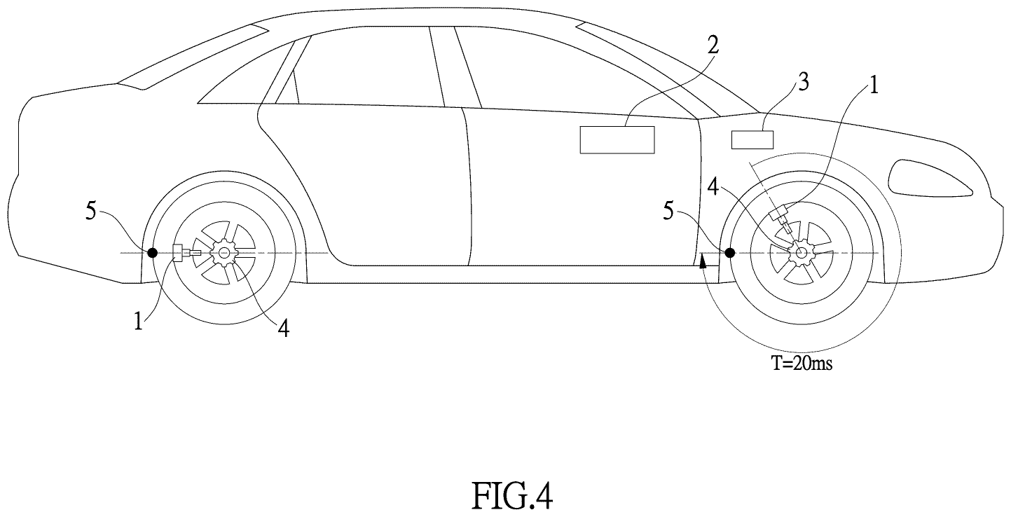

In order to achieve identification of which tire pressure monitor 1 belongs to which wheel, the present invention primarily uses information from the ABS gear 4 for identification. The timing at which the vehicle electronic control unit 2 reads the information of each wheel's ABS gear 4 through the controller is based on the time value needed for each tire pressure monitor 1 to reach the target angular position 5, which serves as the timing point for the vehicle electronic control unit 2 to record the information of each wheel's ABS gear 4, thereby achieving the purpose of identifying which tire pressure monitor 1 belongs to which wheel. As shown in FIG. 2, with the target angular position 5 set at 270 degrees as an example, the right front wheel tire pressure monitor 1 will reach the target angular position 5 in 6 ms after calculation, while the right rear wheel tire pressure monitor 1 will reach the target angular position 5 in 10 ms after calculation. This means the vehicle electronic control unit 2 will record the corresponding tooth count values of each ABS gear 4 at the target angular position 5 after 6 ms and 10 ms respectively. Using the example where the right front wheel tire pressure monitor has ID 3 and the right rear wheel tire pressure monitor has ID 4, after 6 ms, as shown in FIG. 3, the vehicle electronic control unit 2 will record a set of data for the corresponding tooth count values of each ABS gear 4 at the target angular 5 position 5 and mark it as ID3. Subsequently, after another 4 ms, as shown in FIG. 4, the vehicle electronic control unit 2 will record another set of data for the corresponding tooth count values of each ABS gear 4 at the target angular position 5 and mark it as ID4. Following this pattern, after the vehicle electronic control unit 2 records data for several rounds, it will be presented as in the table below.

| | FL Left | FR Right | RL Left | RR Right |
|---|---|---|---|---|
| | Front Wheel | Front Wheel | Rear Wheel | Rear Wheel |
| Tire Pressure | Recorded | Recorded | Recorded | Recorded |
| Monitor ID | Tooth count | Tooth count | Tooth count | Tooth count |
| 3 | 4 | 7 | 6 | 4 |
| 4 | 0 | 3 | 5 | 2 |
| . . . | . . . | . . . | . . . | . . . |
| 4 | 1 | 6 | 3 | 2 |
| . . . | . . . | . . . | . . . | . . . |
| 4 | 5 | 4 | 1 | 2 |

When the tire pressure monitor 1 with ID4 reaches the target angular position 5, the corresponding tooth count value of the ABS gear 4 at the target angular position 5 recorded for the RR right rear wheel is consistently tooth count 2. This information identifies that the tire pressure monitor 1 with ID4 is located on the right rear wheel. The reason is that the relative position between the tire pressure monitor and the corresponding ABS gear does not change, so theoretically, when the tire pressure monitor 1 reaches the target angular position 5 each time, the corresponding tooth count of that wheel's ABS gear 4 at the target angular position 5 does not change. The values for other wheels will show random, irregular numbers due to differences in steering, tire pressure values, alignment, etc. during vehicle movement, causing the actual rotational speeds of each wheel to differ. Following this pattern, the vehicle electronic control unit 2 can correctly identify which tire pressure monitor 1 is located at which wheel position. However, since the present invention uses the time value needed for each tire pressure monitor 1 to reach the target angular position 5 as the timing point for recording data, there will be some margin of error in the data actually recorded. For example, with a 50-tooth ABS gear 4, the tooth count values recorded for the RR right rear wheel when the tire pressure monitor 1 with ID4 reaches the target angular position 5 might be 15, 14, and 16. However, this slight deviation will not affect the identification when compared to the large random differences in the values for other wheels.

In practical applications, the tire pressure monitor 1 of each wheel can use an accelerometer to detect its current angular position and rotational speed on the corresponding wheel.

The target angular position 5 set by each tire pressure monitor 1 can be remotely modified by wirelessly matched devices, such as the vehicle electronic control unit 2, mobile devices, computers, or other equipment connected via Bluetooth or other wireless communication means with two-way connectivity, when there is a need to modify the target angular position 5 set by each tire pressure monitor 1.

While we have shown and described the embodiment in accordance with the present invention, it should be clear to those skilled in the art that further embodiments may be made without departing from the scope of the present invention.

What is claimed is:

1. A method for identifying tire pressure monitor sensors, comprising the following steps:
a tire pressure monitor of each wheel calculating a rotational speed value of a corresponding wheel;
a vehicle electronic control unit reading an information of each wheel's ABS gear 4;
each tire pressure monitor setting a same target angular position, and each tire pressure monitor calculating a time value needed to reach the target angular position based on the rotational speed value of the corresponding wheel;
each tire pressure monitor wirelessly transmitting a packet of the calculated time value to a vehicle electronic control unit, when the time value transmitted by any tire pressure monitor is reached, the vehicle electronic control unit reads a corresponding tooth count value of each wheel's ABS tooth count at the target angular position, after obtaining multiple corresponding tooth count value, a computing element identifies which tire pressure monitor belongs to which wheel based on whether the corresponding tooth count value of each tire pressure monitor are shown and concentrated in a specific tooth count value range or in a dispersed state.

2. The method as claimed in claim 1, wherein each wheel tire pressure monitor uses an accelerometer to detect a current angular position on the corresponding wheel.

3. The method as claimed in claim 1, wherein the each wheel tire pressure monitor uses an accelerometer to detect the rotational speed value.

4. The method as claimed in claim 1, wherein the vehicle electronic control unit reads the information of each wheel's tooth count value through a controller.

5. The method as claimed in claim 1, wherein the target angular position set by each tire pressure monitor is remotely modified by wirelessly matched devices.

6. The method as claimed in claim 1, wherein the computing element is located inside the vehicle electronic control unit or inside a computer or a controller connected to the vehicle electronic control unit.
